(19) United States
(12) Patent Application Publication
(10) Pub. No.: US 2025/0351018 A1
(43) Pub. Date: Nov. 13, 2025

(54) CONDITIONAL MOBILITY FOR WIRELESS COMMUNICATION DEVICES

(71) Applicant: ZTE Corporation, Shenzhen (CN)

(72) Inventors: Mengjie ZHANG, Shenzhen (CN); He HUANG, Shenzhen (CN); Jing LIU, Shenzhen (CN); Fei DONG, Shenzhen (CN)

(73) Assignee: ZTE Corporation, Shenzhen (CN)

(21) Appl. No.: 19/278,082

(22) Filed: Jul. 23, 2025

Related U.S. Application Data
(63) Continuation of application No. PCT/CN2023/076728, filed on Feb. 17, 2023.

(51) Int. Cl. H04W 36/00; H04W 36/36

(52) U.S. Cl. CPC H04W 36/0061; H04W 36/362

(57) ABSTRACT

In wireless communication, a device may change, add, or handover between providers (e.g. nodes) of network access. This may include a conditional cell addition/change procedure and/or a conditional handover procedure. Execution conditions with candidate cell information and configurations may be used for selecting a target cell for the handover to reduce interruption time and improve reliability.

### TECHNICAL FIELD

This document is directed generally to wireless communications. More specifically, in a mobile device communications system, there may be an enhanced conditional cell addition/change procedure.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for changing, adding, or a handover between providers (e.g. nodes) of network access in a wireless communication environment. This may include a conditional cell addition/change procedure and/or a conditional handover procedure. However, some handovers may not allow for successive handover, since the UE may remove all stored candidate cells configuration after completion of the handover to the target cell. Conditional mobility enhancements may support successive/subsequent handover with candidate cells. For example, execution conditions with candidate cell information and configurations may be used for selecting a target cell for the handover to reduce interruption time and improve reliability.

In one embodiment, a method for wireless communication includes receiving candidate cell configurations for one or more candidate cells, and one or more execution conditions associated with each candidate cell; storing the candidate cell configurations; evaluating the one or more execution conditions associated with each candidate cell; and performing execution of a handover to a target cell selected from the candidate cells when the execution condition associated with the target cell is satisfied. The candidate cell comprises at least one of a candidate primary cell (PCell) or a candidate primary secondary cell (PSCell), further wherein the handover comprises at least one of a conditional handover (CHO), or a conditional PSCell addition/change (CPA/CPC). The candidate cell is referred to as a candidate cell group, and further wherein the candidate cell group comprises at least one of a candidate master cell group (MCG) or a candidate secondary cell group (SCG). The method includes receiving, an information for a subsequent cell addition/change, to indicate a handling on candidate cells in dedicated cases. The information for the subsequent cell addition/change comprises at least one of: an indication whether to maintain the candidate cell configurations; an indication which candidate cell configurations to be maintained; an indication on the cell state for the maintained cell configurations; an indication whether to suspend the execution condition evaluation of candidate cells; an indication which candidate cells' execution condition evaluation to be suspended; an indication whether the execution conditions for candidate cells can be used for evaluation for the subsequent cell addition/change; or one or more updated execution conditions of the maintained candidate cells. The dedicated cases comprises a condition: upon execution of CPA/CPC, upon normal PSCell addition/change, upon execution of CHO, upon normal handover, upon SCG release, upon SCG deactivation, upon SCG activation, upon entering into RRC_IDLE, upon entering into RRC_INACTIVTE, or upon transferring from RRC_INACTIVTE to RRC_CONNECTED. The method includes maintaining, the candidate cell configurations, based on the information for the subsequent cell addition/change. The method includes evaluating, the execution conditions for the maintained candidate cells, based on the information for the subsequent cell addition/change. The information for the subsequent cell addition/change is combined with a candidate cell configuration list or is configured within a candidate cell configuration. A state of the candidate cell comprises at least one of a pre-configured state, a pre-configured but suspended state, an activated state, or a deactivated state. For the pre-configured state, a UE stores the cell configuration but does not apply the cell configuration, and the UE evaluates execution conditions on the cell, further wherein for the pre-configured but suspended state the UE stores the cell configuration, does not apply the cell configuration, and the UE suspends evaluation of execution conditions on the cell. The candidate cell comprises a candidate PCell and a candidate PSCell, wherein the execution condition comprises one or more execution conditions for the candidate PCell and one or more execution conditions for the candidate PSCell. When the execution condition(s) for candidate PCell(s) is met but the execution condition for candidate PSCell(s) is not met, the method includes applying the candidate cell configuration for both the candidate PCell and the candidate PSCell; performing a random access to the candidate PCell; and suspending the performing of the random access to the candidate PSCell. The method includes determining the SCG of the candidate PSCell is in deactivated SCG state; or sending an uplink message to inform the state of SCG or to inform that the execution condition of the candidate PSCell is not met.

In another embodiment, a method for wireless communication includes sending, to a wireless communication device, candidate cell configurations for one or more candidate cells; sending, to the wireless communication device, one or more execution conditions associated with each of the one or more candidate cells; causing the wireless communication device to perform execution of a handover to a target cell selected from the candidate cells when the execution condition associated with the target cell is satisfied. The candidate cell comprises at least one of a candidate primary cell (PCell) or a candidate primary secondary cell (PSCell), further wherein the handover comprises at least one of a conditional handover (CHO) or a conditional PSCell addition/change (CPA/CPC). The candidate cell is referred to as a candidate cell group, further wherein the candidate cell group comprises at least one of a candidate master cell group (MCG) or a candidate secondary cell group (SCG). Before the sending, the method further includes sending a request message to a candidate secondary node (SN); and receiving a response message from the candidate SN. The request message comprises at least one of: an indication that the request is for successive/subsequent cell addition/change, a reference configuration, a list of suggested candidate cell identification (ID), a list of candidate cell configuration index, or information for candidate cells prepared by other candidate SNs. The response message comprises at least one of: candidate SCG configurations for the candidate cells, or information for a subsequent cell addition/change. The method includes sending, to the wireless communication device, an information for the subsequent cell addition/change, to indicate a handling of candidate cells in dedicated cases. The information for the subsequent cell addition/change includes: an indication whether to maintain the candidate cell configurations; an indication which candidate cell configurations to be maintained; an indication on the cell state for the maintained cell configurations; an indication whether to suspend the execution condition evaluation of candidate cells; an indication which candidate cells' execution condition evaluation to be suspended; an indication whether the execution conditions for candidate cells can be used for evaluation for the subsequent cell addition/change; or one or more updated execution conditions of the maintained candidate cells. The method includes receiving, from the wireless communication device, a complete message that indicates the execution of a handover to the target cell. The method includes sending, to the candidate SN for the target cell, a SN key, or a counter to indicate a number of times the wireless communication device has switched or accessed the candidate SN or the candidate cell.

In another embodiment, a method for wireless communication includes receiving a request message from a master node (MN); and sending a response message to the MN, wherein the response message includes candidate cell configurations for one or more candidate cells. The receiving and sending is from a candidate secondary node (SN). The request message comprises at least one of: an indication that the request is for successive/subsequent cell addition/change, a reference configuration, a list of suggested candidate cell identification (ID), a list of candidate cell configuration index, or information for candidate cells prepared by other candidate SNs. The response message comprises at least one of: candidate SCG configurations for the candidate cells, or information for a subsequent cell addition/change. The method includes receiving, from the MN, a SN key, or a counter to indicate a number of times the wireless communication device has switched or accessed the candidate SN or the candidate cell. The information for the subsequent cell addition/change includes: an indication whether to maintain the candidate cell configurations; an indication which candidate cell configurations to be maintained; an indication on the cell state for the maintained cell configurations; an indication whether to suspend the execution condition evaluation of candidate cells; an indication which candidate cells' execution condition evaluation to be suspended; an indication whether the execution conditions for candidate cells can be used for evaluation for the subsequent cell addition/change; or one or more updated execution conditions of the maintained candidate cells.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3A shows an embodiment of a user equipment (UE) communicating with nodes.

FIG. 3B shows an embodiment of the user equipment (UE) changing secondary nodes.

FIG. 4 shows one embodiment of a candidate cell signaling structure.

FIG. 5 shows secondary cell group network connections.

FIG. 6 shows an example of cell or cell group (CG) state transfer.

FIG. 7 shows a first embodiment of network communications for a subsequent CPAC configuration and execution.

FIG. 8 shows a second embodiment of network communications for a subsequent CPAC configuration and execution.

FIG. 9 shows a third embodiment of network communications for a subsequent CPAC configuration and execution.

FIG. 10 shows a fourth embodiment of network communications for a subsequent CPAC configuration and execution.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

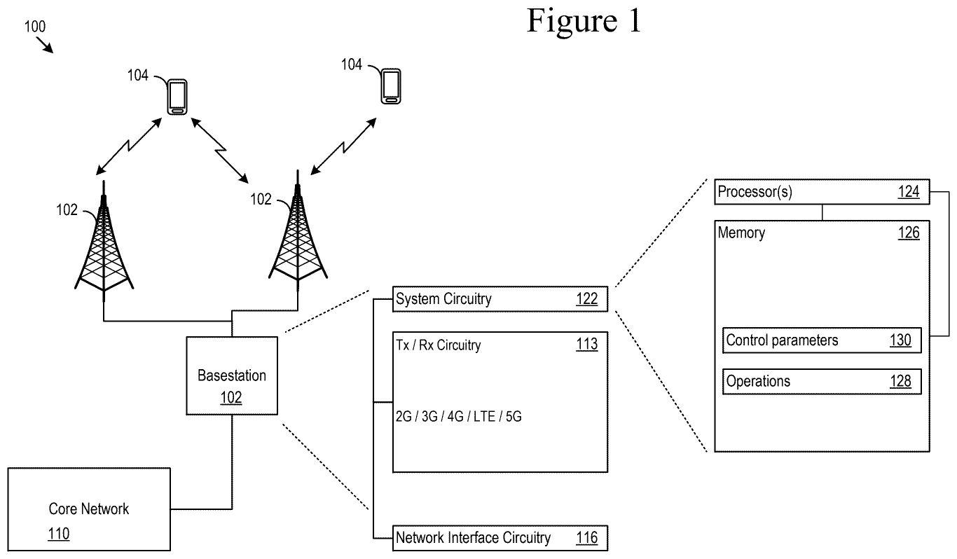

As described below with respect to FIGS. 1-3B, a network provider may include a number of network nodes (i.e. basestations) for providing network access to a user equipment (“UE”) device. The network nodes are referred to as basestations in some embodiments. There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell.

A user equipment (“UE”) device may move between nodes or cells in which case a handover or a change/addition operation may occur to improve network reliability for the UE as it moves. The movement may be from a source secondary node to a target secondary node. There may be a number of potential target secondary nodes that are referred to as candidates. Likewise, the movement between cells may also include a number of target cells that are potential candidate cells. A conditional handover (“CHO”) and a conditional PSCell addition/change (“CPAC”) are described below. The CPAC may include a conditional PSCell change (“CPC”) and/or a conditional PSCell addition (“CPA”).

A conditional handover (“CHO”) can reduce handover interruption time and improve mobility reliability. A CHO is a handover that is executed by the UE when one or more execution conditions are met. The UE can evaluate the execution condition(s) upon receiving the CHO configuration, and can stop evaluating the execution condition(s) once the handover is triggered. The CHO configuration may include a candidate PCell configuration generated by a candidate target node and the corresponding execution condition(s) for that candidate cell.

A conditional PSCell addition/change (“CPAC”) may include the UE having a network configuration for initiating access to a candidate PSCell, either to consider whether the PSCell is suitable for SN addition or SN change including an intra-SN change. This consideration may be based on configured condition(s). The UE in the wireless network can operate in dual connectivity (“DC”), including intra-E-UTRA DC or Multi-Radio DC (“MR-DC”). In the example of intra-E-UTRA DC, both the MN and SN provide E-UTRA access. While in the example of MR-DC, one node may provide new radio (“NR”) access and the other one provides either E-UTRA or NR access.

In CPAC/CHO, some inter-node interaction may allow for the transfer of suggested candidate cell(s) information, execution condition(s), and/or accepted candidate cell(s) information between the MN, source SN, and target SN. Due to the deployment of high frequency and smaller cell size, PCell/PSCell changes may occur frequently in NR. Accordingly, successive handovers or PSCell changes may be required to reduce handover interruption time and improve mobility reliability. However, CHO/CPC may not applicable to successive handover/PSCell change, since the UE removes all stored candidate cells configuration after completion of handover or PSCell addition/change to the target cell. The embodiments described below include conditional mobility enhancements to support successive/subsequent CHO/CPAC, CHO with candidate cells (e.g. SCGs).

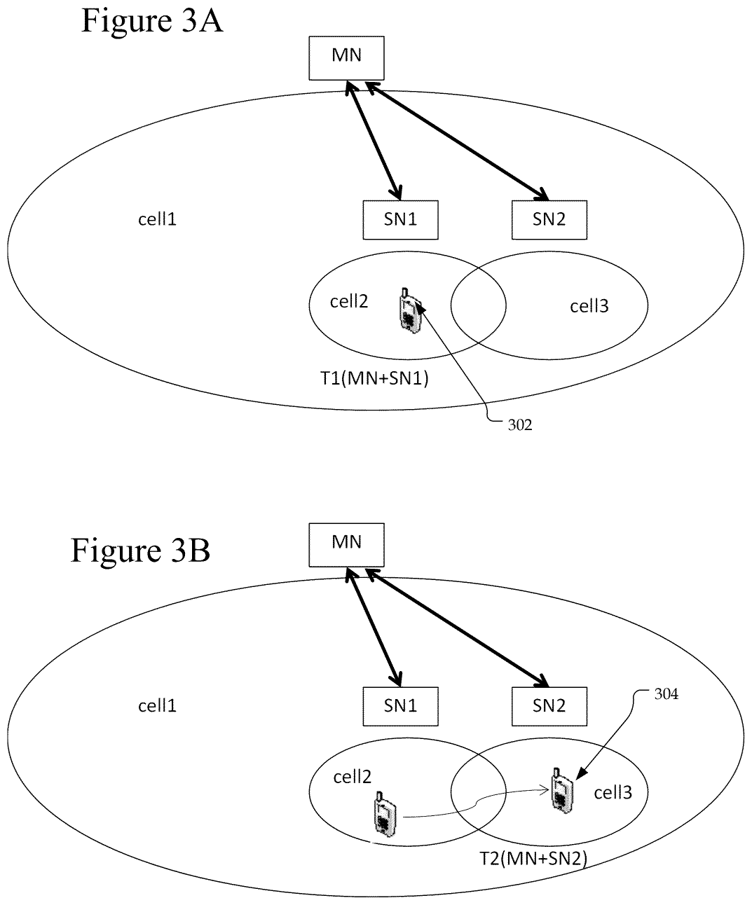

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

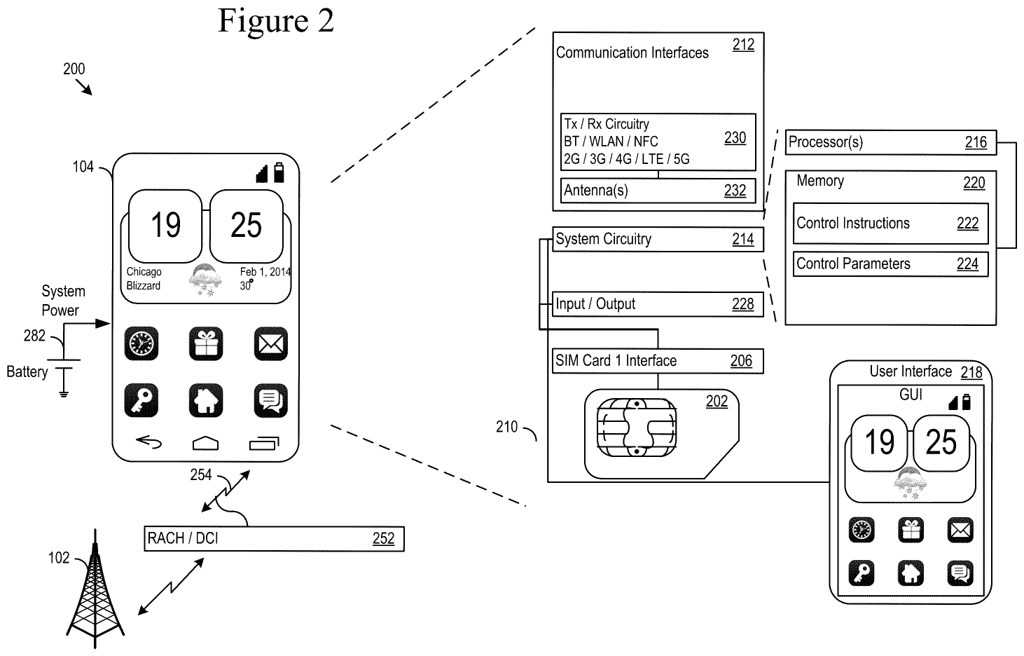

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). On embodiment is shown in FIGS. 3A-3B. Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U (MN) interface instance.

FIG. 3A shows an embodiment of a user equipment (UE) communicating with nodes. The master node (“MN”) generates a first cell cell1. There are two secondary nodes (“SN”) labeled as SN1 and SN2. The cell for SN1 is cell2 and the cell for SN2 is cell3. Each of the three network nodes provides a corresponding cell for user equipment (“UE”) to connect to the network. The UE 302 is shown at a first time T1 within range of MN and SN1. As shown, the UE 302 is operating in dual connectivity (“DC”) between MN and SN1.

FIG. 3B shows an embodiment of the user equipment (UE) changing secondary nodes. The UE 304 is shown as moving from time T1 (where it was in cell2) to be in cell3 at time T2, where it is in cell3 or MN+SN2. With the movement of the UE from 302 to 304 as shown in FIG. 3A to FIG. 3B, the SN is changed from SN1 to SN2. As described below, SN change can be initiated either by the MN or the source SN. In FIG. 3B, SN1 is the source SN and SN2 is the target SN.

To reduce interruption time and improve mobility reliability during a SN change or SN addition, a Conditional PSCell Addition/Change (“CPAC”) is described. CPAC may include a PSCell addition/change that is executed by the UE when one or more execution conditions are met. The UE evaluates the one or more execution conditions upon receiving the CPAC configuration, and stops evaluating the one or more execution conditions once a PSCell addition/change is triggered. The CPAC configuration may include the candidate PSCell configuration generated by the candidate SN and the corresponding one or more execution conditions for candidate PSCell. According to the initiation node of the CPAC procedure, CPAC may be categorized as MN initiated CPAC and SN initiated CPAC. According to the impact of MN, the CPAC procedure may be classified as CPAC with MN involvement and CPAC without MN involvement (i.e. intra-SN CPC without MN involvement).

### Selective Activation of Cell Group (CG) Change

For selective activation of cell group (CG) change, the network/basestation may pre-configure multiple candidate CG configurations and send to the UE. The UE stores multiple candidate CG configurations. The UE can perform CG change among candidate CGs based on the network/basestation indication/signaling (e.g. RRC message, MAC CE) or the pre-configured execution conditions. The candidate cell may be referred to as candidate cell group (CG) interchangeably. The candidate CG may be referred to as candidate MCG or candidate SCG. The candidate cell may be referred to as candidate PCell in MCG, or candidate PSCell in SCG. For an MCG change, the selective activation of CG change may be referred to as subsequent/successive CHO, selective activation of MCG/PCell, conditional selective MCG/PCell, etc. For SCG change, the selective activation of CG change may be referred to as subsequent/successive CPC, subsequent/successive CPA, subsequent/successive CPAC, selective activation of SCG/PSCell, conditional selective SCG/PSCell, etc. In some embodiments, SCG/PSCell change (e.g. CPC) is taken as examples, but is applicable to MCG/PCell change as well.

An example baseline procedure for subsequent SCG change may include:
The NW sends a RRC Reconfiguration message including multiple candidate PSCell/SCG configurations and the execution conditions of candidate PSCell/SCG to the UE.
The UE stores multiple candidate PSCell/SCG configurations and evaluates the execution conditions of candidate PSCell/SCG. When the execution condition of a candidate PSCell/SCG is met, the UE performs the execution of CPA or CPC towards this candidate PSCell.
After finishing the PSCell addition or change, the UE may not release the conditional configuration of other candidate PSCells for subsequent CPA/CPC, the UE continues evaluating the execution conditions of other candidate PSCells.
When the execution condition of a candidate PSCell is met, the UE performs the execution of CPA or CPC towards this candidate PSCell.

### Candidate Cell/CG Configurations

For candidate cell/CG configurations, the candidate SCG configurations may have a signaling structure with the following options:
Option 1: all candidate SCG configurations are configured in parallel in RRC message (e.g. a list of conditional reconfiguration for candidate PSCells, similar as legacy CPC configuration signaling structure); or
Option 2: candidate SCG configurations can be included in one candidate SCG configuration (e.g. CPC configuration in CPC/CPA configuration) or/and normal PSCell addition/change command.

The reference configuration can be defined to reduce the overhead for each candidate cell. Each candidate cell may have multiple part configurations to generate the complete configuration. The candidate cell configuration may use source configuration for baseline, and reconfiguration of the different part for the candidate cell is used to improve performance. Delta configuration may be the different/other part of the reference configuration. The LTM candidate cell configuration can be configured with the delta configuration. The delta configuration is generated based on the reference configuration. The reference configuration definition may be with the following options:

Option 1: The reference configuration is explicitly configured by the NW (i.e. a separate reference configuration).

Option 1-1: Specify/indicate one of the candidate cells as the reference configuration (e.g. the network/basestation indicates the reference cell index within each candidate cell configuration).

Option 1-2: Define one reference configuration independent from the candidate cell configuration.

Option 2: The reference configuration is the UE configuration when the candidate cell configuration is received, i.e. the initial source configuration.

Option 3: The reference configuration is the UE configuration when the cell switch command is received. In one example, the network/basestation provides cells 1, 2, 3 then the UE maintains configuration for each so does not need to provide the update for each candidate configuration, which is based on the pre-configurations.

Option 3-1: For each candidate cell, the network/basestation pre-configures several candidate delta configurations, each one is configured based on possible source cell (e.g. the initial source cell, other candidate cells).

Option 3-2: Upon reception of the candidate cell configuration, for each candidate cell, the UE translates the received the candidate cell configuration and generates a set of delta configuration based on possible source cell.

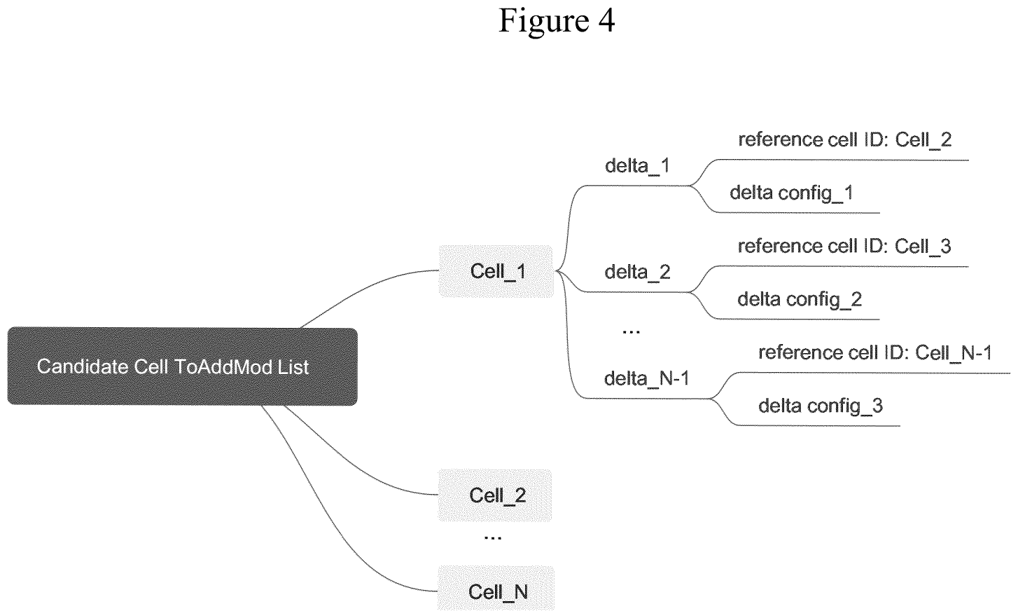

FIG. 4 shows one embodiment of a candidate cell signaling structure. Specifically, FIG. 4 may apply to Option 3 above. For each candidate cell, there may be a set of delta configurations, where each delta configuration is linked with a reference cell ID (e.g. other candidate cell index). If the reference cell ID is absent, it may imply that the delta configuration is generated based on the initial source configuration.

The candidate cell/CG configuration may include a MCG part and a SCG part. The reference configuration may also include a MCG and a SCG part. The MCG part may be generated by the MN. The MCG part may be the current MCG configuration. The SCG part may be generated by the source SN or the candidate SN.

The reference configuration can be configured:
Alt. 1: a full set of cell configuration, e.g. RRC reconfiguration message, containing MCG part and SCG part;
Alt. 2: a set/pool of common configuration among multiple cells/CGs, e.g. a common measurement configuration; or
Alt. 3: several sets of reference configuration for different configuration part, e.g. one or a set of reference MCG configuration, one or a set of reference SCG configuration.

Upon reception the reference and/or candidate cell/CG configuration, the UE may perform the following operations:
Alt. 1: The UE stores the reference configuration and/or candidate cell/CG configuration separately, such as by storing the reference configuration as a separate configuration (e.g. store the reference configuration into the VarReferenceConfig). If the reference configuration is the initial source configuration, the UE may store the source configuration as a separate configuration upon reception of the candidate cell configurations or upon completion of the initial/first PSCell change (e.g. initial CPC execution); or
Alt. 2: The UE translates each delta configuration into full configuration, and stores the full configuration for each candidate cell.

Upon triggering the execution of cell/CG addition/change (e.g. when the execution condition of candidate PSCell is met), the UE behavior may include:
Alt. 1: the UE firstly restores or reverts back to the reference configuration, and then applies the delta configuration of the target candidate cell/CG, based on the reference configuration; or
Alt. 2: the UE directly applies the delta configuration for the target candidate cell/CG, which is based on the current source configuration, e.g. for option 3 above, applying the delta configuration linked with the reference index to refer to the current source cell.
   Handling on Source and/or Candidate Cell/CG Configurations

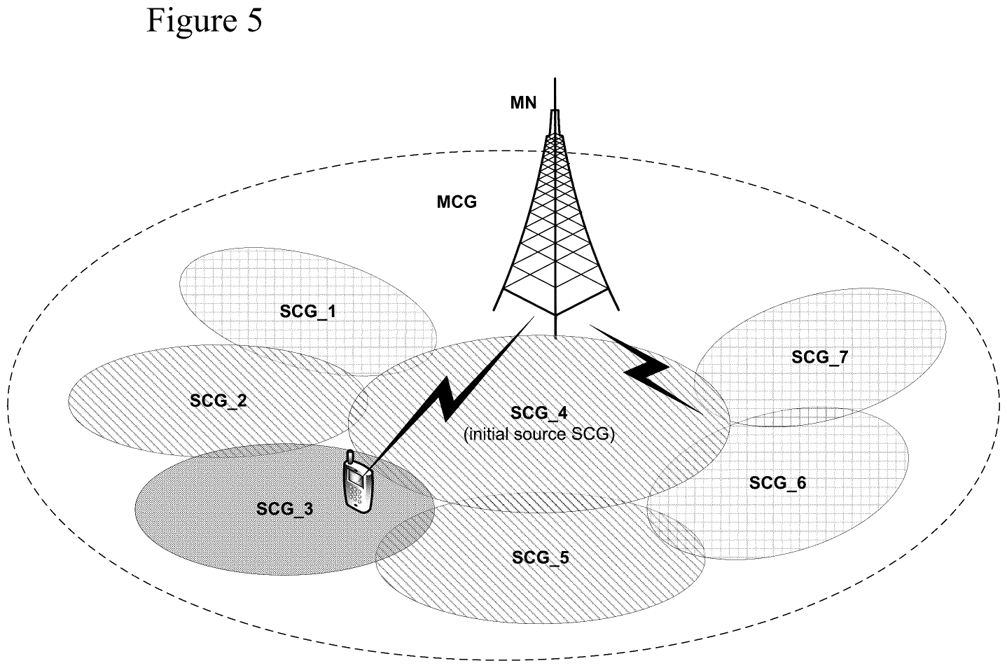

The source and/or candidate CG configuration may be handled as shown in FIG. 5. FIG. 5 illustrates secondary cell group network connections. For the initial source SCG/PSCell, the network/basestation can configure the source SCG/PSCell as one of the candidate SCG configurations (e.g. as a candidate cell within the conditional reconfiguration), if the NW wants to use it for subsequent SCG addition/change. In order to support the subsequent SCG change, the candidate SCG configurations may be maintained after one SCG addition or change (e.g. CPA/CPC or normal PSCell addition/change). As shown in FIG. 5, with the UE's movement, when UE moves to one specific candidate SCGs, some other candidate SCGs may be not suitable as candidates for the subsequent SCG change. For example, when UE resides in SCG_3, the SCG_2, SCG_4, SCG_5 could be the candidate SCGs for the next SCG change, but the SCG_1, SCG_6, SCG_7 are not available for the next CG change.

The handling of candidate SCG configurations may be used in different cases, such as: upon execution of CPA/CPC, upon normal PSCell addition/change, upon SCG release, upon SCG deactivation or activation, upon handover or MCG change, upon entering into RRC_IDLE, upon entering into RRC_INACTIVTE, upon transferring from RRC_INACTIVTE to RRC_CONNECTED (e.g. reception of RRCResume message). Some options that are considered include:
Option 1: the UE autonomously release the stored candidate SCG configurations, i.e. similar to the current CPAC handling; or
Option 2: the network/basestation explicitly indicates how to handle the stored candidate SCG configuration, e.g. indicating the information for subsequent CPC via an RRC message or MAC CE

The network/basestation (MN, source SN or candidate/target SN) may indicate/configure some information for subsequent CPAC. The information for subsequent handover could be provided per candidate PSCell, per candidate SN or for a set of candidate PSCells/SNs (e.g. all prepared candidate PSCells/SNs). The information may include at least one of:
Indication whether to maintain prepared candidate SCG/PSCell configurations;
Indication which candidate SCG/SCell configurations could be maintained;
Indication on the SCG state for the maintained SCG/PSCell configurations, e.g. whether to suspend the execution condition evaluation of candidate PSCell;
Indication whether the initial execution conditions could be used for subsequent CPC; or
New/updated execution conditions of the maintained candidate PSCell.

The information for subsequent CPAC may be included in the RRC Reconfiguration message (e.g. for handover, CHO, CPC/CPA, normal PSCell addition/change, SCG release, SCG deactivation/activation), RRC Release message (e.g. entering into RRC_IDLE, entering into RRC_INACTIVTE), or RRC Resume message (transferring from RRC_INACTIVTE to RRC_CONNECTED), etc.

In some embodiments, for each candidate cell or for all configured/indicated candidate cells, the network/basestation (the MN, source SN or candidate/target SN) can determine/indicate/configure at least one of:
a cell list to indicate which candidate cells are maintained or released when the UE accesses to the candidate cell, e.g. when applying the candidate cell configuration or when the UE successfully completes random access to the candidate cell; or
a cell list to indicate which candidate cells are available/maintained for the next cell change or which candidate cells' evaluation shall be continued when the UE moves/accesses to the candidate cell, e.g. when applying the candidate cell configuration or when the UE successfully completes random access to the candidate cell. In this example, the UE shall maintain prepared candidate cell configurations, but whether to keep or stop the evaluation on the execution conditions for other candidate cells when the UE moves to the candidate cell is based on the NW indication: 1) If a cell is available for the next cell change or if the evaluation on the cell is indicated to be continued, the UE shall keep the evaluation on the execution condition for the cell; or 2) If a cell is not available for the next cell change or if the evaluation on the cell is indicated to be stopped/suspended, the UE shall stop/suspend the evaluation on the execution condition for the cell. In another example, execution conditions may be reconfigured/provided/updated with the maintained candidate cell/cell.

The signaling structure may include:
Alt. 1: A candidate cell information list directly configured in the RRC message (e.g. RRCReconfiguration, RRCRelease, RRCResume message). For each candidate cell in the list, it links with a maintained/subsequent candidate cell list for the subsequent CG change. Each item in the maintained/subsequent candidate cell list includes candidate cell ID (e.g. candidate cell configuration index), and may also include the execution conditions for that candidate cell, or/and an indication to indicate whether the UE needs to keep the evaluation of the cell, etc.
Alt. 2: the candidate cell configuration includes conditional configuration of candidate cells for subsequent CG change (e.g. CPC configuration in CPC/CPA configuration) For example, the candidate cell configuration (the RRCReconfiguration contained in condRRCReconfig) includes the candidate cell ID (i.e. condReconfigId), or/and the execution conditions (i.e. condExecutionCond/condExecutionCondSCG) for other candidate PSCells (for subsequent CPC).

In some embodiments, the absence of the execution condition of the candidate cell may imply indicate the evaluation of the candidate cell execution condition shall be stopped/suspended.

In one example, an ASN.1 structure for Alt.1 (e.g. include the maintained cell list or/and the associated execution conditions for the subsequent CPC into the current CondReconfigToAddMod-r16 IE) may include:

CondReconfigToAddModList information element

```
  -- ASN1START
  -- TAG-CONDRECONFIGTOADDMODLIST-START
  CondReconfigToAddModList-r16 ::= SEQUENCE (SIZE (1.. maxNrofCondCells-r16)) OF
CondReconfigToAddMod-r16
  CondReconfigToAddMod-r16 ::= SEQUENCE {
```

| condReconfigId-r16 | CondReconfigId-r16, | |
|---|---|---|
| condExecutionCond-r16 | SEQUENCE (SIZE (1..2)) OF MeasId | OPTIONAL, |

-- Need M

| | |
|---|---|
| condRRCReconfig-r16 | OCTET STRING (CONTAINING RRCReconfiguration) |

```
OPTIONAL, -- Cond condReconfigAdd
    ...,
    [[
```

| | |
|---|---|
| condExecutionCondSCG-r17 | OCTET STRING (CONTAINING |

```
CondReconfigExecCondSCG-r17) OPTIONAL -- Need M
  ]]
  [[
```

| | |
|---|---|
| subseqCondConfigToAddModList-xy | SubseqCondConfigToAddModList-xy |

OPTIONAL, -- Need N

| | |
|---|---|
| subseqCondConfigToRemoveList-xy SubseqCondConfigToRemoveList-xy | OPTIONAL, |

```
-- Need N
    ]]
  }
  CondReconfigExecCondSCG-r17 ::= SEQUENCE (SIZE (1..2)) OF MeasId
  SubseqCondConfigToRemoveList-xy ::= SEQUENCE (SIZE (1..maxNrofCondCells-r16-1)) OF
CondReconfigId-r16
  SubseqCondConfigToAddMod-xy ::= SEQUENCE {
```

| condReconfigId-r16 | CondReconfigId-r16, | |
|---|---|---|
| condExecutionCond-r16 | SEQUENCE (SIZE (1..2)) OF MeasId | OPTIONAL, |

-- Need M

| | |
|---|---|
| condExecutionCondSCG-r17 | OCTET STRING (CONTAINING |

```
CondReconfigExecCondSCG-r17) OPTIONAL -- Need M
    ...
  }
  -- TAG-CONDRECONFIGTOADDMODLIST-STOP
  -- ASN1STOP
```

### Candidate Cell/CG State

In some embodiments, the candidate cell/CG state transfer may be considered. Considering the UE may maintain the candidate cell/cell group (CG) configuration for a period of time to support the subsequent CG change, it may be necessary to define the cell/CG state for each candidate cell/CG. The candidate cell may include candidate PCell and/or candidate PSCell. The candidate CG may include candidate MCG and/or candidate SCG.

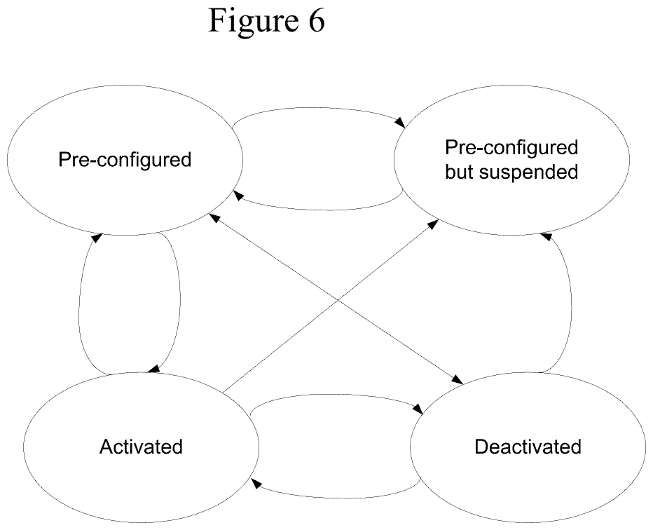

FIG. 6 shows an example of cell or cell group (CG) state transfer. For each candidate Cell/CG, it may have the following state:
Pre-configured state: the UE stores/maintains the cell/CG configuration but the cell/CG configuration is not applied, and the UE performs the evaluation of the execution conditions on the cell/CG;
Pre-configured but suspended state: the UE stores/maintains the cell/CG configuration but the cell/CG configuration is not applied, and the UE stops/suspends the evaluation of the execution conditions on the cell/CG;
Activated state: the UE behavior is the same as the current activated serving cell/CG, e.g. perform DL reception/UL transmission with the cell, perform radio link monitoring and/or beam failure detection on the cell, perform measurements on the cell, etc; or
Deactivated state: the UE behavior is the same as the current deactivated serving cell/CG, e.g. suspend DL reception/UL transmission with the cell, perform radio link monitoring and/or beam failure detection on the cell if indicated by the network/basestation (e.g. for deactivated SCG, the bfd-and-RLM is configured to true).

The candidate cell/CG in a pre-configured but suspended state may not consume any UE capability related to measurement performing or execution condition evaluation. The candidate cell/CG in a pre-configured state and/or pre-configured but suspended state may not consume any UE capability for the serving cell (including the activated and deactivated serving cell).

When receiving candidate cell/CG configurations from the network/basestation, the UE may consider all stored candidate cells/CGs to be in a pre-configured state or pre-configured but suspended state.

In one embodiment, PSCell/SCG state handling is taken as an example. To go from pre-configured state to a pre-configured but suspended state may include:
Based on the NW/basestation indication/configuration to indicate the execution condition evaluation on the candidate PSCell/SCG are suspended, e.g. according to the information for subsequent CPAC, the UE considers the candidate PSCell/SCG in pre-configured but suspended state, and stops/suspends the evaluation of the execution conditions on the PSCell/SCG.

To go from a pre-configured but suspended state to a pre-configured state may include:
Based on the NW/basestation indication/configuration to indicate the execution condition evaluation on the candidate PSCells/SCGs are maintained/continued (e.g. according to the information for subsequent CPAC), or reception of the new/updated execution conditions from the NW/basestation (e.g. MN, target SN), the UE considers the candidate PSCell/SCG in pre-configured state, and starts/re-starts the evaluation of the execution conditions on the PSCell/SCG.

To go from a pre-configured state to an activated state may include:
When the execution condition of the candidate PSCell/SCG is met, and the UE selects the candidate PSCell/SCG as target cell; or when the NW sends a PSCell addition/change command to indicate the target PSCell, the UE applies the configuration of the target PSCell/SCG, performs PSCell/SCG addition/change to the target cell, and considers the PSCell/SCG is in activated state.

To go from a pre-configured state to a deactivated state may include:
When receiving a network/basestation signaling to indicate that the candidate PSCell/SCG is deactivated; or when the execution condition of the candidate PSCell/SCG is not met, but the execution condition of the associated candidate PCell/MCG is met (in case of CHO with candidate SCGs), the UE applies the PSCell/SCG configuration, and/or considers the PSCell/SCG is in deactivated state.

To go from an activated state to a deactivated state/pre-configured state/pre-configured but suspended state may include: when performing PSCell/SCG addition/change (including CPA/CPC) from the source to the target, the activated source cell(s) may be transferred into deactivated state/pre-configured state/pre-configured but suspended state, based on the NW indication; or when receiving a network/basestation signaling (e.g. RRC signaling, MAC CE) to indicate the state transfer.

To go from a deactivated state to an activated state/pre-configured state/pre-configured but suspended state may include: when receiving a network/basestation signaling (e.g. RRC signaling, MAC CE) to indicate the state transfer; or when performing PSCell/SCG addition/change (including CPA/CPC) or handover (including CHO) from the source to the target, the deactivated source cell(s) may be transferred into activated state/pre-configured state/pre-configured but suspended state, based on the NW indication. For the state transfer between activated and deactivated, it may be at least it is applicable to SCell and SCG.

### Execution Condition

There may be execution conditions for each of the cells. To provide the execution condition for subsequent CG change, there may be at least two options:
Option 1: The network/basestation pre-configures execution conditions for subsequent cell group changes when preparing candidate cell group configurations; or
Option 2: The network/basestation updates/re-configures execution conditions for subsequent cell group changes after completion of one cell group addition or change.

In one embodiment, there may be CPA and MN initiated CPC. The execution conditions (A4/B1 events) may be generated by the MN, based on MCG MeasConfig. In order to support subsequent CPC, A3/A5 events could be considered for MN initiated CPC, where the candidate PSCell is compared with the current/serving PSCell. Regarding the execution conditions for the subsequent CPC (i.e. for MN initiated CPC), the initial pre-configured execution conditions may be reused for the subsequent CPC.

In another embodiment, there may be SN initiated CPC. For both SN initiated intra-SN CPC and SN initiated inter-SN CPC, the execution conditions (A3/A5 events) are generated by the source SN, based on SCG MeasConfig. Since the initial execution conditions are configured based on the source SCG measurement configuration, the execution conditions may become invalid after one SCG change. The execution conditions for the subsequent SCG change may be pre-configured by the target/candidate SN or be updated by the target/candidate SN after completion one SCG change.

### Security Issue

There may be a security issue for a subsequent SCG change. The UE may switch back to the previous cell, but the security parameters (e.g. sk-counter) may have been reused. The UE may reuse the same security key to transmit the new date packet with the same cell when switching back to the previous cell, which may cause a security issue due to the reuse of the same key+COUNT+RB ID. In order to handle the security key issue (e.g. the same sk-counter/S-KgNB is used while the UE connected to SN #1 before and after being connected to SN #2), there are several options:
Option 1: The network/basestation (e.g. MN) provides a common sk-counter for all candidate SCGs to UE, the sk-counter will be incremented by specified step after each SCG addition/change. Upon SCG addition/change, the MN may need to inform the new SN key to the target SN/SCG (e.g. when receiving the RRC complete message from the UE).
Option 2: The network/basestation (e.g. MN) pre-configures a list of sk-counter for each candidate SN/SCG, e.g. the UE derives the secondary key based on the master key and the Nth provided sk-counter for the Nth time activating/switching to the SN/SCG. The network/basestation (e.g. MN or SN) and the UE may need to maintain a counter for each candidate SN/SCG to record the times the UE switches to the same SN/SCG. For example, at the first time the UE switches to a candidate SN/SCG (e.g. counter=0), the first sk-counter in the list is used. At the second time the UE switches to the same candidate SN/SCG (e.g. counter=1), the second sk-counter in the list is used.
Option 3: There may be a new SN security key derivation method with a new counter as a key derivation material. The counter is used to record how many times the UE has accessed/switched to the same candidate SN/SCG. Then the SN and/or the UE can use the counter value and the initial sk-counter to derive the new SN key for the candidate SN/SCG. For example, at the first time the UE switches to a candidate SN/SCG, the counter value=0 at the second time the UE switches to the same candidate SN/SCG, the counter value=1, and so on.
Option 4: the UE shall not perform PDCP state variables reset (e.g. COUNT reset) upon SN/SCG change. For example, the UE maintains multiple set of PDCP state variables, each one is associated with a SN/SCG that the UE has previously accessed/switched to. When the UE switches back to the previous SN/SCG, the UE shall revert back to the PDCP state variables of that SN/SCG.

Regarding how to inform the target SN about the new SN key, there are several options:
if the new SN key is derived by the MN, the MN informs the new SN key to the target SN, e.g. when receiving the RRC complete message from the UE. For example, a S-NG-RAN node Security Key IE can be introduced in the S-NODE RECONFIGURATION COMPLETE message.
if the new SN key is derived by the target SN, the MN informs an indication about the counter of the SN/SCG change (the times that the UE switches to the same candidate SN/SCG, e.g. counter=2 means the second SN/SCG change to the same SN/SCG) to the target SN/SCG, e.g. when receiving the RRC complete message from the UE. For example, a SCG Change Counter IE can be introduced in the S-NODE RECONFIGURATION COMPLETE message. Then the target SN derives the SN key by itself, based on the initial SN key and the counter value of the SN/SCG change.

### Subsequent CPAC Configuration and Execution

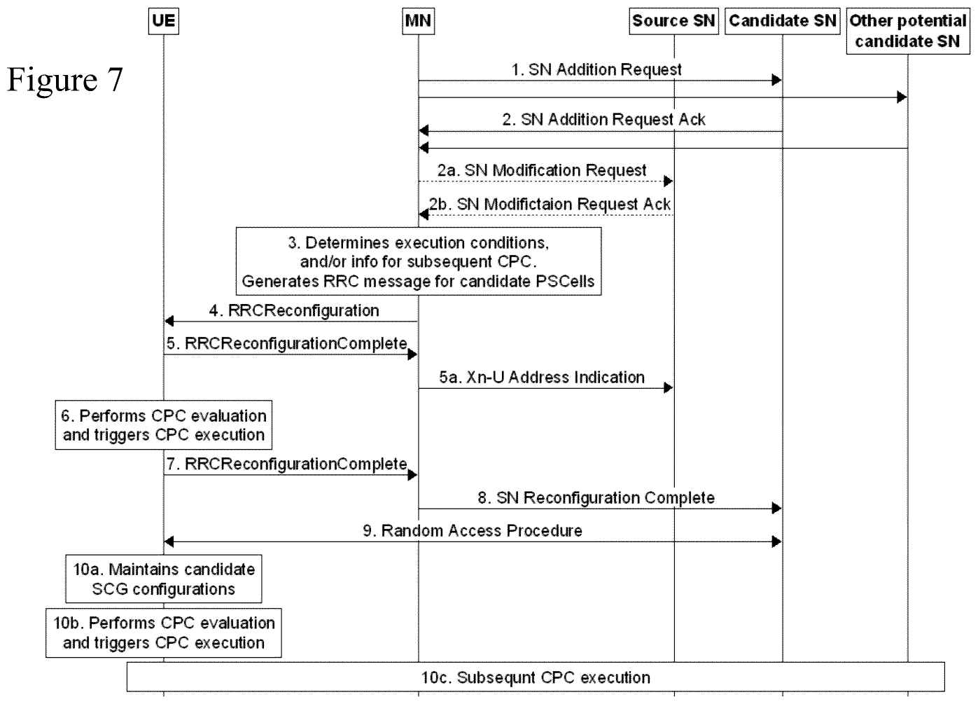

FIG. 7 shows a first embodiment of network communications for a subsequent CPAC configuration and execution. In this embodiment, the initial SCG addition/change (e.g. CPA, CPC) is initiated by the MN. The execution conditions for the initial SCG addition/change is determined by the MN. The information for the subsequent CPAC may be determined by the MN. The information may be provided per candidate PSCell, per candidate SN or for a set of candidate PSCell/SN (e.g. all prepared candidate PSCells). The information may include at least one of:
Indication whether to maintain prepared candidate SCG configurations,
Indication which SCG configurations could be maintained,
Indication on the SCG state for the maintained SCG configurations, e.g. whether to suspend the execution condition evaluation of candidate PSCell
Indication whether the initial execution conditions could be used for subsequent CPC
New/updated execution conditions of the maintained candidate PSCell

As shown in FIG. 7, the signaling communications are described below.

Step 1. The MN sends SN Addition Request message to the candidate SN to initiate the conditional SN addition or change (i.e. CPA, CPC). The message may include an indication to indicate that the request is for successive/subsequent CPAC, and/or the reference SCG configuration. Before the step 1, the MN may initiate the SN modification request procedure towards the source SN to request the reference SCG configuration, if the reference configuration is generated by the source SN.

Step 2. The candidate SN generates candidate SCG configurations of candidate PSCell (e.g. based on the reference SCG configuration). And the candidate SN sends the prepared candidate PSCell ID(s) and the candidate SCG configuration(s) to the MN. Step 2a/b. If the MN determines to add the source PSCell/SCG as a candidate for the subsequent CPC, the MN may initiate the SN modification request procedure towards the source SN. The MN sends to the source SN the SN modification request message, which may include an indication to request that the source PSCell/SCG is prepared as a candidate for the subsequent CPAC, and/or the reference SCG configuration. The source SN may generate/update the SCG configuration (e.g. based on the reference configuration) and sends that to the MN. In some embodiments, the procedure to request preparing/configuring the source PSCell as a candidate may be performed together with the procedure to request reference SCG configuration (e.g. before step 1).

Step 3. The MN determines the execution condition(s) for each prepared candidate PSCell. The MN may also determine/indicate the information for subsequent CPAC, e.g. maintained candidate cell list, execution conditions for each maintained/prepared candidate PSCell. The MN generates RRC reconfiguration message, including candidate PSCell configurations, execution conditions for each candidate PSCell, and/or the information for subsequent CPAC.

Step 4. The MN sends the generated RRC reconfiguration message to the UE.

Step 5. The UE response the RRC reconfiguration complete message to the MN.

Step 5a. The MN informs the source SN that the CPAC or subsequent/successive CPAC has been configured via Xn/X2 message, e.g. via Xn-U Address indication message. If applicable, the source SN starts early data forwarding. In some embodiments, the MN may also inform the source SN that the source PSCell/SN has been configured as a candidate for subsequent CPAC via the Xn/X2 message.

Step 6. The UE starts evaluate the execution conditions. If the execution condition for one candidate PSCell is met, the UE performs CPAC execution to the target PSCell, e.g. including to apply the candidate cell configuration of that PSCell, and perform random access to that PSCell.

Step 7. The UE sends RRCReconfigurationComplete message to the MN. The message may include the information enabling the MN to identify the SN of the selected candidate PSCell.

Step 8. The MN sends SN Reconfiguration Complete message to the target SN. The message may also indicate a new SN key, and/or a counter to indicate how many times the UE has switched to that candidate SN or candidate PSCell/SCG. In some embodiments, the MN may initiate SN Release procedure to the source SN and/or other candidate SNs to cancel CPAC in that SN(s), if these SNs are not configured/indicated as candidate SNs for the subsequent CPAC. The MN may also initiate SN modification procedure to the source SN and/or other candidate SNs to modify the candidate PSCells in that SN(s), e.g. to cancel some candidate PSCells if that cell(s) is not configured/indicated as candidate cell(s) for the subsequent CPAC.

Step 9. The UE synchronizes to the selected target PSCell (e.g. performing random access).

Steps 10a-c. The UE maintains candidate PSCell configuration(s), e.g. based on the network/basestation indication, and performs evaluation of execution conditions on the maintained candidate PSCells or the candidate PSCells that are required to perform execution condition evaluation (if indicated by the network/basestation). If the execution condition for one candidate PSCell is met, the UE performs subsequent CPAC execution to the selected target PSCell.

In some embodiments, for the CPA configuration and execution, the source SN and steps related to the source SN could be ignore/skipped.

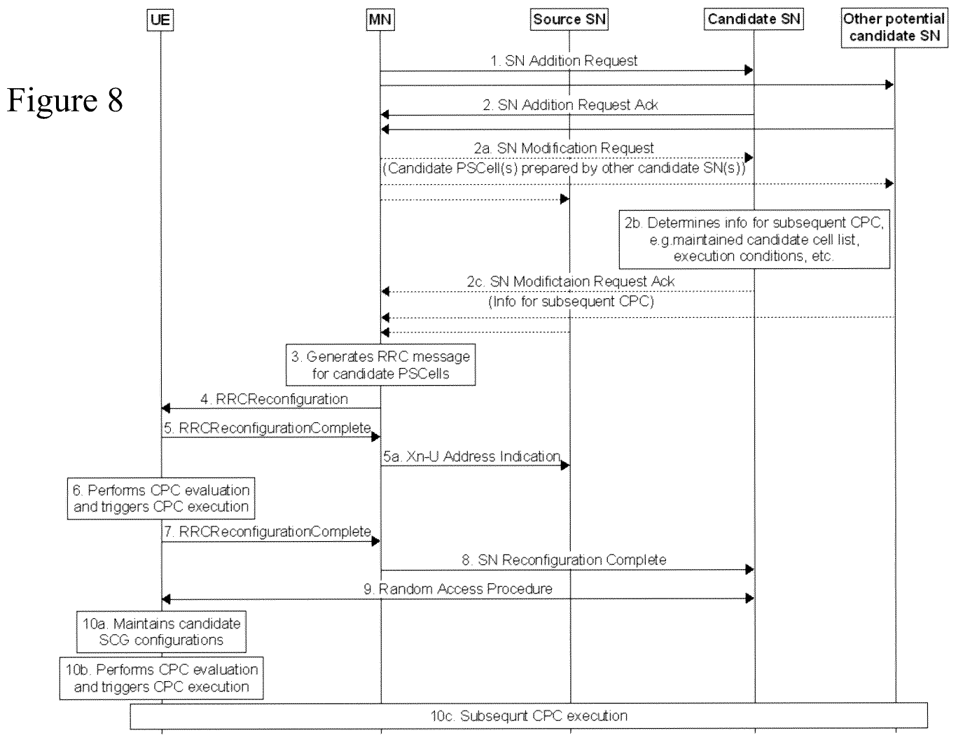

FIG. 8 shows a second embodiment of network communications for a subsequent CPAC configuration and execution. The initial SCG addition/change (e.g. CPA, CPC) is initiated by the MN. The execution conditions for initial SCG addition/change is determined by the MN. The information for subsequent CPAC could be determined by the target/candidate SN. As shown in FIG. 8, the signaling communications are described below.

Step 1-2. These steps may be similar to steps 1-2 in the first embodiment shown in FIG. 7.

Step 2a. The MN sends SN modification request message to the candidate SN to request that the candidate SN prepares information for subsequent CPAC. The message may include include an indication to indicate that the request is for successive/subsequent CPAC, a list of candidate cell configuration index, and/or the information/configuration for candidate PSCell(s) prepared by other candidate SN(s), e.g. a list of candidate SN ID, and/or a list of candidate PSCell IDs.

Steps 2b/c. The candidate SN generates the information for subsequent CPAC, e.g. maintained candidate cell list, execution conditions for each maintained candidate PSCell prepared by that candidate SN. The candidate SN sends SN modification request acknowledge message to the MN. In some embodiments, the step to prepare information for subsequent CPAC may be combined with the SN addition procedure (i.e. step 1/2). The SN addition request message may include the information/configuration for candidate PSCell(s) prepared by other candidate SN(s), e.g. a list of candidate SN ID, and/or a list of candidate PSCell ID. The candidate SN may generate the information for subsequent CPAC and send such information to the MN via SN addition request acknowledge message. In some embodiments, if the MN or the candidate SN determines to add the source PSCell/SN as a candidate for the subsequent CPC, the MN may initiate the SN modification request procedure towards the source SN. If the determination is made by the candidate SN, the candidate SN may send an indication to the MN to indicate that the source PSCell/SN could be a candidate for subsequent CPAC, e.g. via SN addition request acknowledge message. In the SN modification request procedure, the MN sends to the source SN the SN modification request message, which may include an indication to request that the source PSCell/SCG is prepared as a candidate for the subsequent CPAC, a list of candidate cell configuration index, the information or configuration for candidate PSCell(s) prepared by other candidate SN(s), and/or the reference SCG configuration. The source SN may generate/update the SCG configuration (e.g. based on the reference configuration) and/or information for subsequent CPAC. The source SN informs the MN about the generated configuration and/or information.

Step 3. The MN determines the execution condition(s) for each prepared candidate PSCell for initial CPAC. The MN generates RRC reconfiguration message, including candidate PSCell configurations, execution conditions for each candidate PSCell, and/or the information for subsequent CPAC.

Steps 4-10. These steps may be similar to steps 4-10 in the first embodiment shown in FIG. 7.

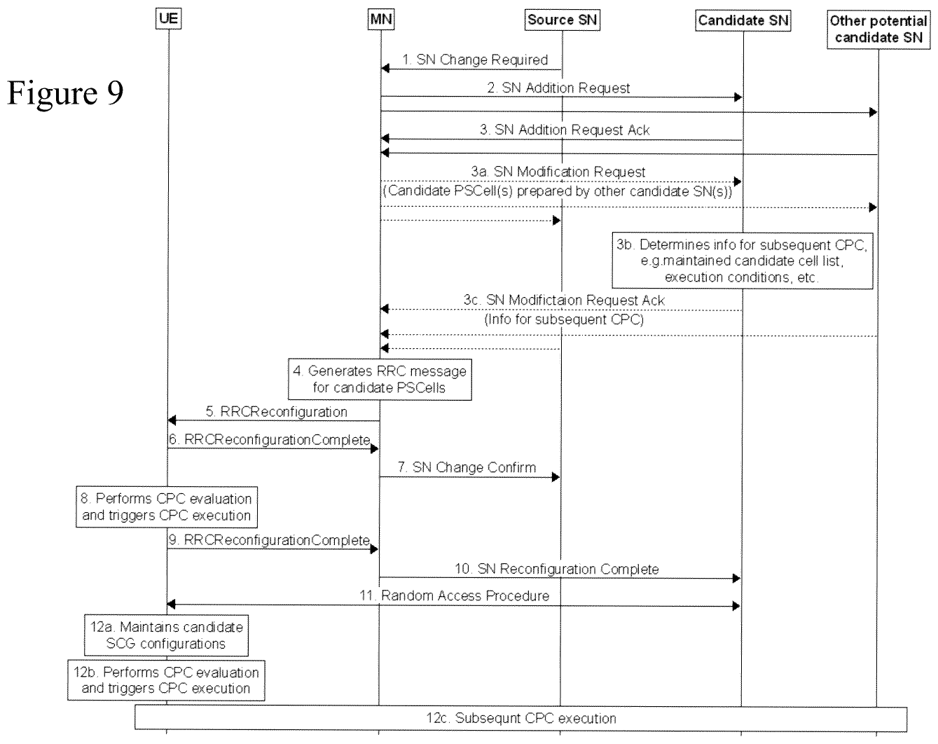

FIG. 9 shows a third embodiment of network communications for a subsequent CPAC configuration and execution. The initial SCG change (e.g. CPC) is initiated by the source SN. The execution conditions for initial SCG change is determined by the source SN. The information for subsequent CPAC could be determined by the target/candidate SN. As shown in FIG. 9, the signaling communications are described below.

Step 1. The source SN initiates the conditional SN change procedure by sending SN change required message to the MN. The message may include an indication to indicate that the request is for successive/subsequent CPAC, candidate SN ID(s), and/or the reference SCG configuration. The message also includes a list of proposed PSCell candidates recommended by the source SN, and execution conditions associated with each proposed PSCell candidate.

Steps 2-3. These steps may be similar to steps 1-2 in the second embodiment shown in FIG. 8.

Steps 3a-3c. These steps may be similar to steps 2a-c in the second embodiment shown in FIG. 8.

Step 4. The MN generates RRC reconfiguration message, including candidate PSCell configurations, execution conditions for each candidate PSCell, and/or the information for subsequent CPAC.

Steps 5-6. These steps may be similar to steps 4-5 in the second embodiment shown in FIG. 8.

Step 7. The MN sends SN Change Confirm message to inform the source SN, which may contain the SN RRCReconfigurationComplete message received from the UE. The message may also include and an indication that the source PSCell/SN has been configured as a candidate for subsequent CPAC.

Steps 8-12c. These steps may be similar to step 6-10c in the second embodiment shown in FIG. 8.

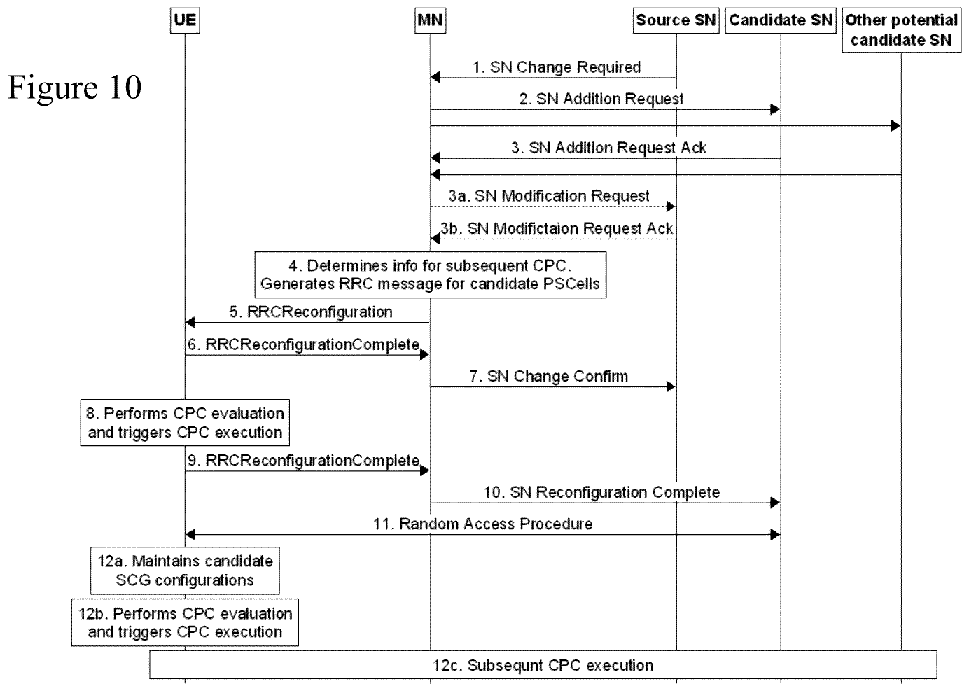

FIG. 10 shows a fourth embodiment of network communications for a subsequent CPAC configuration and execution. The initial SCG change (e.g. CPC) is initiated by the source SN. The execution conditions for initial SCG change is determined by the source SN. The information for subsequent CPAC could be determined by the MN. As shown in FIG. 10, the signaling communications are described below.

Step 1. This step may be similar to step 1 in the third embodiment shown in FIG. 9.

Steps 2-3b. These steps may be similar to steps 1-2b in the first embodiment shown in FIG. 7.

Step 4. The MN may determine/indicate the information for subsequent CPAC, e.g. maintained candidate cell list, execution conditions for each maintained/prepared candidate PSCell. The MN generates RRC reconfiguration message, including candidate PSCell configurations, execution conditions for each candidate PSCell, and/or the information for subsequent CPAC.

Steps 5-12c. These steps may be similar to steps 5-12c in the third embodiment shown in FIG. 9.

In some embodiments, the indication/information above transferred between the MN and the SN can be configured by one of the following options:

Option 1: Include the indication/information as one information element directly in a Xn/X2 message.

Option 2: Include the indication/information in a RRC message, e.g. CG-Config/CG-ConfigInfo message. The RRC message is included as one information element in a Xn/X2 message.

CHO with Candidate SCGs

For CHO with candidate SCGs, the network/basestation provides candidate PCell configuration with candidate PSCell configuration, and execution conditions for candidate PCell and candidate PSCells. In order to perform the evaluation of execution conditions for candidate PCell and candidate PSCell, there may be several options:
Option 1: the UE performs the evaluation on candidate PCells and candidate PSCells simultaneously, i.e. parallel evaluation.
Option 2: sequential evaluation, which may include: Option 2a for the UE firstly evaluates candidate PCells, and then starts the evaluation on candidate PSCells when the execution conditions for at least one candidate PCell is met; or Option 2b for the UE firstly evaluates candidate PCells, and then starts the evaluation on candidate PSCells when the UE executes CHO to the target candidate PCell (e.g. completion of random access to the target candidate PCell).

For option 1 and option 2a, the UE may perform the PCell change with PSCell change when execution conditions for both candidate PCell and PSCell are met. For option 2b, the UE firstly performs PCell change (may with/without PSCell change), and then performs PSCell change.

The signaling structure to configure candidate PCell with candidate PSCell (i.e. CHO configuration with CPAC configuration), may have several alternatives:
Alt. 1: one candidate PCell configuration is associated with multiple candidate PSCell configurations;
Alt. 2: one candidate PCell configuration is associated with one candidate PSCell configurations, e.g. there may be multiple CHO configuration, each one may include the same PCell but different PSCells;
Alt. 3: candidate PCell configuration and candidate PSCell configuration are configured separately, i.e. independent CHO and CPAC configuration(s). And there is association between CHO configuration and CPAC configuration, e.g. link the CHO candidate configuration index with CPAC candidate configuration index; or.
Alt. 4: candidate PSCell configurations are included in the candidate PCell configuration, i.e. CPAC configuration contained in CHO configuration.

Alt. 1-3 may correspond to the option 1 or option 2a above. Alt. 4 may correspond to option 2b above. In Alt. 1-3, the execution conditions for candidate PSCells may be determined by the source MN or the source SN, e.g. source MN for MN initiated CPA/CPC, source SN for SN initiated CPC. In Alt. 4, the execution conditions for candidate PSCells may be determined by the target MN or the target SN, e.g. target MN for MN initiated CPA/CPC, target SN (if configured in CHO configuration) for SN initiated CPC.

The network/basestation may configure a leaving execution condition or a timer for the candidate PCell and/or candidate PSCell. The leaving execution condition can be a threshold, e.g. RSRP/RSRQ/SINR threshold configured by the MN or the SN. For example, if the measurement of candidate cell becomes below the threshold, the UE considers the leaving condition(s) of candidate cell is met. The execution condition or the leaving execution condition may include event A3, A5, A4, and/or B1. The execution condition may include one or more measId(s) associated with the events. If event(s) associated to all measId(s) within the (leaving) execution conditions (e.g. condTriggerConfig) for a candidate cell are fulfilled, the UE considers the (leaving) execution conditions for candidate cell is met.

In an example where the execution conditions for candidate PCell is met, the UE detects whether the execution conditions for candidate PSCell is met or not. In a first example, if the execution conditions for candidate PSCell is met, the UE performs PCell change with PSCell change, i.e. the UE performs random access to the target PCell and the target PSCell. In a second example, if the execution conditions for candidate PSCell is not met, the UE may perform the following behavior:
Alt. 1: the UE directly performs PCell change without PSCell change, i.e. the UE only performs random access to the target PCell, but not for the target PSCell.
Alt. 2: if the (leaving) execution condition is configured by the network/basestation, the UE detects whether the leaving execution condition of the candidate PCell (whose execution condition was met) is met. If the leaving execution condition of the candidate PCell is not met, the UE continues to evaluate candidate PSCells: If the execution condition of candidate PSCell is met and the leaving execution condition of the candidate PCell is not met, the UE performs PCell change with PSCell change. Otherwise, if the leaving execution condition of the candidate PCell is met, the UE performs PCell change without PSCell change.
Alt. 3: if a timer is configured by the network/basestation, the UE starts the timer for the candidate PCell (whose execution condition was met), and continues to evaluate the execution conditions for candidate PSCell. If the timer is running, and the execution condition of candidate PSCell is met, the UE stops the timer and/or performs PCell change with PSCell change. If the timer expires, the UE performs PCell change without PSCell change.

In an example where the execution conditions for candidate PSCell is met, the UE detects whether the execution conditions for candidate PCell is met or not. In a first example, if the execution conditions for candidate PCell is met, the UE performs PCell change with PSCell change. In a second example, if the execution conditions for candidate PCell is not met, the UE continues to evaluate the execution conditions for candidate PCell, including:
Alt. 1: If the condition of candidate PCell is met and the leaving entry of the execution condition of candidate PSCell is not met, the UE performs PCell change with PSCell change.
Alt. 2: If the condition of candidate PCell is met and the leaving execution condition of candidate PSCell is not met (if configured by the network/basestation), the UE performs PCell change with PSCell change.

In an example where the execution condition(s) for candidate PCell(s) is met but the execution condition(s) for candidate PSCell(s) is not met, the UE may stop the evaluation of execution condition(s) for candidate PSCell(s), apply the whole CHO candidate configuration (including MCG and SCG configuration), and/or perform the random access to the target PCell, but suspend/not to perform random access to the target PSCell, e.g. keep the SCG in deactivated state. In some embodiments, the UE may inform the target MN via RRC reconfiguration complete message, e.g. include an indication to indicate that the SCG is in deactivated state, or inform that the execution condition(s) for candidate PSCell(s) is not met. The target MN may also inform the target SN via Xn/X2 message, e.g. include an indication to indicate that the SCG is in deactivated state in SN Reconfiguration Complete message. In some embodiments, the UE may continue/re-start to evaluate the execution conditions for PSCell, e.g. upon reception of the updated/new execution conditions from the NW. When the execution condition for PSCell is met, the UE may perform random access to the PSCell, e.g. perform the UE triggered SCG activation.

### Measurement for Mobility Control

For a measurement for mobility control and/or height reporting, the measurement report may be triggered by event H1 or H2. The event H1 or H2 may include:
Event H1: The Aerial UE height is above a threshold; or
Event H2: The Aerial UE height is below a threshold.

The UE can trigger a measurement report to the network/basestation when the UE detects UE's altitude/height is above (i.e. event H1) or below (i.e. event H2) of a network/basestation-configured height threshold. The measurement report may contain the UE's height, location information and/or RSRP/RSRQ/SINR measurement results. The network/basestation may configure/provide at least one of the following indications to indicate which content can be included in the measurement report triggered by event H1/H2:
An indication whether UAV UE's height is required to be included, e.g. including includeHighetInfo IE in the ReportConfig.
An indication whether the RSRP/RSRQ/SINR measurement result is required to be included, e.g. including includeQuantities IE in the ReportConfig. The indication may include separate indications to indicate whether the RSRP is required, whether the RSRQ is required and/or whether the SINR is required. In some embodiments, if only event H1 and/or H2 is configured, the UE may not need to perform RSRP/RSRQ/SINR measurement on serving cells and/or neighbour cells if the corresponding measurement result is not required to be included in the measurement report.
An indication to indicate whether the location information (if available) is required to be included, e.g. including includeCommonLocationInfo IE in the ReportConfig.

Different types of events/conditions can be combined to make the measurement reporting or mobility triggered only if both conditions are fulfilled simultaneously. In an example, the combination of conditions may be configured as the execution condition(s) for conditional mobility (e.g. CHO. CPAC), e.g. the UE shall trigger the execution of CHO or CPAC only if both events/conditions in the execution condition(s) are met. At least two of the following conditions can be combined:
Height-based condition, e.g. event H1/H2
RSRP/RSRQ/SINR-based condition, e.g. event A1˜A6, event B1/2
Distance-based condition, e.g. event D1
Time-based condition, e.g. event T1
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
Event B1: Neighbour becomes better than absolute threshold;
Event B2: PCell becomes worse than absolute threshold1 AND Neighbour becomes better than another absolute threshold2;
Event D1: Distance between UE and a reference location referenceLocation1 becomes larger than configured threshold distanceThreshFromReference1 and distance between UE and a reference location referenceLocation2 becomes shorter than configured threshold distanceThreshFromReference2; and
Event T1: Time measured at UE becomes more than configured threshold t1-Threshold but is less than t1-Threshold+duration.

In order to combine different types of conditions/events, e.g. height-based condition and RSRP/RSRQ/SINR-based condition, there may be several options to be considered:
Option 1: define new event(s) to include different types of conditions, e.g. height-dependent condition and RSRP/RSRQ/SINR-based condition
Option 2: configure association for existing events, e.g. combine event H1 or H2 with event Ax through measurement ID
Option 2a: one measurement ID to link one measurement object with multiple report configuration (e.g. one report configuration for event H1/2, the other report configuration for event Ax). The UE shall initiate the measurement report or mobility only when event(s) included in all report configuration associated to the measId are fulfilled.
Option 2b: combination of multiple measurement IDs (e.g. one measurement ID for event H1/2, the other report configuration for event Ax). A combined measurement ID (e.g. combinedMeasId) can be introduced to include a list of measId(s), to indicate the combination of the included measId(s). The UE shall initiate the measurement report or mobility only when event(s) associated to all measId(s) within combinedMeasId are fulfilled.

In option 2a, determining whether all events in the combined event are met may include:
For each event in the report configuration associated with the measId, if the entry condition(s) applicable for this event in the report configuration, is fulfilled for the applicable cells for all measurements after layer 3 filtering taken during the corresponding timeToTrigger defined for this event, the UE may set the measurement results in the measurement report, and consider the event associated to that measId to be fulfilled.
For each event in the report configuration associated with the measId, if the leaving condition(s) applicable for this event, is fulfilled for the applicable cells for all measurements after layer 3 filtering taken during the corresponding timeToTrigger defined for this event, the UE may set the measurement results in the measurement report, and consider the event associated to that measId to be not fulfilled.
If the event(s) in the all report configuration associated to the measId are fulfilled, the UE may initiate the measurement reporting procedure or trigger the mobility (e.g. CHO, CPAC).

In option 2b, regarding determining whether all events in the combined event are met may include:
For each measId, if the entry condition(s) applicable for this event in the report configuration associated with the measId, is fulfilled for the applicable cells for all measurements after layer 3 filtering taken during the corresponding timeToTrigger defined for this event, the UE may set the measurement results in the measurement report, and consider the event associated to that measId to be fulfilled.
For each measId, if the leaving condition(s) applicable for this event in the report configuration associated with the measId, is fulfilled for the applicable cells for all measurements after layer 3 filtering taken during the corresponding timeToTrigger defined for this event, the UE may set the measurement results in the measurement report, and consider the event associated to that measId to be not fulfilled.
If event(s) associated to all measId(s) within combinedMeasId are fulfilled, the UE may initiate the measurement reporting procedure or trigger the mobility (e.g. CHO, CPAC).

An example of the procedure text is shown as below:

| | |
|---|---|
| 1> | for each measId included in the measIdList within VarMeasConfig: |

...

| | |
|---|---|
| 2> | if the reportType is set to eventTriggered and if the entry condition applicable for this |

event, i.e. the event corresponding with the eventId of the corresponding reportConfig within
VarMeasConfig, is fulfilled for one or more applicable cells for all measurements after layer 3
filtering taken during timeToTrigger defined for this event within the VarMeasConfig, while the
VarMeasReportList does not include a measurement reporting entry for this measId (a first cell
triggers the event):

| | |
|---|---|
| 3> | include a measurement reporting entry within the VarMeasReportList for this measId; |
| 3> | set the numberOfReportsSent defined within the VarMeasReportList for this measId |

to 0;

| | |
|---|---|
| 3> | include the concerned cell(s) in the cellsTriggeredList defined within the |

VarMeasReportList for this measId;

| 3> | if useT312 is set to true in reportConfig for this event: | |
|---|---|---|
| | 4> | if T310 for the corresponding SpCell is running; and |
| | 4> | if T312 is not running for corresponding SpCell: |
| | | 5> start timer T312 for the corresponding SpCell with the value of T312 |
| | configured in the corresponding measObjectNR; | |
| | 3> | if the measId for the corresponding reportConfig including the reportType, associates |

with the other measId, or is included in the combinedMeasId:

| 4> consider the event associated to that measId to be fulfilled; | |
|---|---|
| 3> | else |

```
    4> initiate the measurement reporting procedure, as specified in 5.5.5;
    ...
```

| | |
|---|---|
| 1> | for each combinedMeasId included in the combinedMeasIdList within VarMeasConfig: |
| 2> | if event(s) associated to all measId(s) within combinedMeasId are fulfilled: |
| | 3> initiate the measurement reporting procedure, as specified in 5.5.5; |

A combined TTT (e.g. combinedTimeToTrigger) can be configured for the combination of events. The combined TTT may be triggered only if the entry condition when both events are met or if the leaving condition for any one of the events is met.

For a height-dependent RRM configuration, the network/basestation can configure multiple sets of RRM configuration (e.g. measurement object configuration, report configuration, etc.). Each set may be associated with different height thresholds or different height range. The UE may apply the associated RRM configuration when the UE's height is above or below the corresponding height threshold. Alternatively, the UE may apply the associated RRM configuration when the UE's height is belonging to the corresponding height range. The measurement object configuration may include the measured beam information (e.g. ssb-ToMeasure), measured cell list (e.g. cellsToAddModList, excludedCellsToAddModList, allowedCellsToAddModList), etc. The measurement report configuration may include the event threshold, hysteresis, timeToTrigger, etc.

In order to avoid the mismatch between the network/basestation and the UE, there are several embodiments for informing the network/basestation about the RRM configuration applied by the UE:
Option 1: the network/basestation configures multiple event H1/H2 with different height thresholds, which corresponds to the height thresholds associated with different sets of RRM configuration. The network/basestation can know/defer which set of RRM configuration is applied by the UE, according to the height report triggered by event H1/H2.
Option 2: the UE informs the network/basestation which set of RRM configuration is applied via UL message, e.g. sending the applied RRM configuration set index via UE assistance information message

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication, performed by user equipment, comprising:
receiving candidate cell configurations for candidate cells, one or more first execution conditions associated with each of the candidate cells, and information for a subsequent cell addition/change associated with each of the candidate cells to indicate candidate cell handling in dedicated cases, wherein the information for the subsequent cell addition/change comprises at least one of a subsequent/maintained candidate cell list or one or more second execution conditions associated with each candidate cell in the subsequent/maintained candidate cell list, and wherein the dedicated cases comprises performing candidate cell handling upon execution of a conditional primary cell (PSCell) addition/change (CPA/CPC), upon a normal PSCell addition/change, upon an execution of a conditional handover (CHO), upon a normal handover, or upon a secondary cell group (SCG) release;
storing the candidate cell configurations;
evaluating the one or more first execution conditions associated with each of the candidate cells; and
performing execution of a handover to a target cell selected from the candidate cells when the first execution condition associated with the target cell is satisfied, wherein the candidate cells comprise PSCells, wherein the handover comprises a CPA or a CPC.

2.-6. (canceled)

7. The method for wireless communication of claim 1, further comprising:
maintaining the candidate cell configurations based on the information for the subsequent cell addition/change.

8. The method for wireless communication of claim 7, further comprising:
evaluating the one or more second execution conditions associated with each candidate cell in the subsequent/maintained candidate cell list based on the information for the subsequent cell addition/change.

9. (canceled)

10. The method of claim 1, wherein a state of each of the candidate cells comprises at least one of a pre-configured state, a pre-configured but suspended state, an activated state, or a deactivated state.

11. (canceled)

12. The method for wireless communication of claim 1, wherein the candidate cells comprise a candidate primary cell (PCell) and in addition to the candidate PSCells.

13. (canceled)

14. (canceled)

15. A method for wireless communication, performed by a base station, comprising:
sending, to a wireless communication device, candidate cell configurations for one or more candidate cells, one or more first execution conditions associated with each of the candidate cells, and information for a subsequent cell addition/change associated with each of the candidate cells to indicate candidate cell handling in dedicated cases, wherein the information for the subsequent cell addition/change comprises at least one of a subsequent/maintained candidate cell list or one or more second execution conditions associated with each candidate cell in the subsequent/maintained candidate cell list, and wherein the dedicated cases comprises performing candidate cell handling upon execution of a conditional primary cell (PSCell) addition/change (CPA/CPC), upon a normal PSCell addition/change, upon an execution of a conditional handover (CHO), upon a normal handover, or upon a secondary cell group (SCG) release; and
causing the wireless communication device to perform execution of a handover to a target cell selected from the candidate cells when the first execution condition associated with the target cell is satisfied, wherein the candidate cells comprise PSCells, wherein the handover comprises a CPA or a CPC.

16. (canceled)

17. (canceled)

18. The method for wireless communication of claim 15, wherein before sending, to the wireless communication device, the candidate cell configurations, the method further comprises:
sending a request message to a candidate secondary node (SN); and
receiving a response message from the candidate SN.

19. The method for wireless communication of claim 18, wherein the request message comprises at least one of: an indication that the request message is for successive/subsequent cell change, a reference configuration, or information for candidate cells prepared by other candidate SNs.

20. The method for wireless communication of claim 18, wherein the response message comprises at least one of: candidate SCG configurations for the candidate cells, or the information for a subsequent cell addition/change.

21. (canceled)

22. (canceled)

23. The method for wireless communication of claim 15, further comprising:
receiving, from the wireless communication device, a complete message that indicates the execution of the handover to the target cell.

24. The method for wireless communication of claim 23, further comprising:
sending, to a candidate secondary node (SN) for the target cell, an SN key, or a counter to indicate a number of times the wireless communication device has switched or accessed the candidate SN or the target cell.

25. A method for wireless communication, performed by a candidate secondary node (SN), comprising:
receiving a request message from a master node (MN), wherein the request message comprises at least one of: an indication that the request message is for successive/subsequent cell change, a reference configuration, or information for candidate cells prepared by other candidate SNs; and
sending a response message to the MN, wherein the response message includes candidate cell configurations for the candidate cells, wherein the response message comprises at least one of: candidate SCG configurations for the candidate cells, or information for a subsequent cell addition/change comprising at least one of a subsequent/maintained candidate cell list or one or more execution conditions associated with each candidate cell in the subsequent/maintained candidate cell list.

26.-32. (canceled)

33. The method of claim 1 further comprising:
receiving a list of sk-counters for each candidate secondary node (SN);
deriving a secondary key based on a master key and a sk-counter in the list of sk-counters corresponding to a switch to a candidate SN; wherein the sk-counter is an Nth entry in the list of sk-counters corresponding to an Nth switch to the candidate SN.

34. The user equipment of claim 1, comprising at least one processor and a memory, wherein the at least one processor is configured to read code from the memory to execute the method of claim 1.

35. The base station of claim 15, comprising at least one processor and a memory, wherein the at least one processor is configured to read code from the memory to execute the method of claim 15.

36. The candidate SN of claim 25, comprising a at least one processor and a memory, wherein the at least one processor is configured to read code from the memory to execute the method of claim 25.

37. The user equipment of claim 33, comprising at least one processor and a memory, wherein the at least one processor is configured to read code from the memory to execute the method of claim 33.

38. The user equipment of claim 7, comprising at least one processor and a memory, wherein the at least one processor is configured to read code from the memory to execute the method of claim 7.

39. The user equipment of claim 8, comprising at least one processor and a memory, wherein the at least one processor is configured to read code from the memory to execute the method of claim 8.

40. The base station of claim 18, comprising at least one processor and a memory, wherein the at least one processor is configured to read code from the memory to execute the method of claim 18.
